(19) United States
(12) Patent Application Publication
(10) Pub. No.: US 2024/0239522 A1
(43) Pub. Date: Jul. 18, 2024

(54) SYSTEMS AND APPARATUS FOR A CONFIGURABLE ANNEX BASE (CAB) ON AN ORBITAL TRANSFER VEHICLE (OTV) FOR PAYLOAD RIDESHARE MISSIONS

(71) Applicant: Spaceflight Inc., Bellevue, WA (US)

(72) Inventors: Adam Hadaller, Bellevue, WA (US); Erik Lund, Reston, VA (US)

(73) Assignee: Spaceflight Inc., Bellevue, WA (US)

(21) Appl. No.: 18/192,831

(22) Filed: Mar. 30, 2023

Related U.S. Application Data
(60) Provisional application No. 63/383,475, filed on Jan. 12, 2023.

(51) Int. Cl. B64G 1/64

(52) U.S. Cl. CPC B64G 1/641; B64G 1/645

(57) ABSTRACT

A sophisticated avionics system for the safe and reliable deployment and tracking of multiple commercial payloads at once includes an apparatus that holds multiple payloads on an orbital transfer vehicle (OTV). The apparatus has a base structure with a primary port system containing one of adapters and adapter plates that connect payloads to the OTV. The base structure has an auxiliary port system with the number of primary ports being equal to the number of auxiliary ports. The primary ports and auxiliary ports include adapters configured to connect a payload to the OTV. The order of ports around the base structure alternates between primary and auxiliary ports. The base structure contains a forward port capable of holding more weight than can be held by the primary and auxiliary ports. The base structure contains a rear port capable of connecting the OTV to a launch vehicle (LV).

### BACKGROUND

Some embodiments are directed to a system of avionics including payload deployment operations, payload detachment software, attitude adjustment software, electronic hardware, radiation control, thermal control, propulsion systems operation, anti-collision software, recontact analysis software, etc. Embodiments are intended to be applicable in the use of systems, methods, and apparatus relating to avionics for a spacecraft, space tug, orbital transfer vehicle (OTV), launch vehicle (LV) satellite, etc.

A variety of spacecraft missions are under development to keep up with the increased commercial activity in the field of satellites. Satellite or payload “rideshares” allow commercial entities to send their small satellites to space for a lower price than previously possible. A sophisticated avionics system is necessary for the safe and reliable deployment and tracking of multiple commercial payloads at once.

### BRIEF DESCRIPTION OF THE DRAWINGS

FIG. 1 is a forward-facing view of the CAB structure with views of the front port, primary ports, and auxiliary ports;

FIG. 2 is a view of a 5-sided ESPA ring containing 5 primary ports, 5 auxiliary ports, a rear port, and a front port;

FIG. 3 is a view of the CAB shown in FIG. 1 with clear boxes to show possible spaces for payloads;

FIG. 4 is a more in-depth view of the primary ports shown in FIG. 3 using the flat plate seen in FIG. 11;

FIG. 5 is a more in-depth view of the primary ports shown in FIG. 3 using a circular plate;

FIG. 6 is a view of a possible forward port on the CAB and a payload measurement guide for payloads attached to the forward port;

FIG. 7 is a more in-depth view of the auxiliary ports shown in FIG. 3;

FIG. 8 is a view of a possible ring spacer used to space the OTV from the launch vehicle;

FIG. 9 is a view of the possible ring spacer used on the forward port shown in FIG. 6.

### SUMMARY

The present disclosure is directed towards a novel apparatus, method, and system and design for an OTV including a hexagonal ESPA-ring-like base or Configurable Annex Base (CAB). This system provides a larger payload volume for small satellites to be held on the OTV. In some embodiments, the design involves payload adaptor rings, multiple small satellite components, launch vehicle components, hinges, adaptors, and small-sat release mechanisms. In some embodiments, the small satellite components (including microsats, cubesats, and cubesat deployers) are mounted onto a payload adaptor ring or payload adapter plate.

In some embodiments, the main backbone of the CAB is an Evolved Expendable Launch Vehicle (EELV) Secondary Payload Adapter (ESPA) ring structure with ports that may connect to payloads attached to an OTV. Some embodiments of the CAB use the ESPA ring as a referential starting point but contain hexagonal-shaped ring structures instead of circular ones. Some embodiments contain a circular ring structure connected to an external hexagonal plate structure which includes a standard ESPA ring or ESPA ring derivative as a base.

### DETAILED DESCRIPTION OF EXEMPLARY EMBODIMENTS

I. EELV Secondary Payload Adapter (ESPA)
II. Cubesat and Microsat Payloads
III. Configurable Annex Base (CAB)
IV. CAB Adapter Plates and Payload Connection
V. Ring Spacers
VI. J-Channel and Propellant Systems
VII. Sherpa-FX, Sherpa-ES, Sherpa-AC, Sharps-LTC, and Sherpa-LTE
VIII. Orbitals
IX. Radial Payload Grouping
X. Pocketed Plate
XI. Attitude Control
XII. Hosted Payloads
XIII Testing of Parts, Software, Hardware, Payloads, CAB, and OTV

The present disclosure relates to the base structure of an OTV or other satellite deployment vehicle. This base is herein referred to as the Configurable Annex Base (CAB). The name CAB is used to describe the present invention in detail and is not meant to limit the present disclosure in any way.

### (1) EELV Secondary Payload Adapter (ESPA)

In some embodiments, the main backbone of the CAB is an Evolved Expendable Launch Vehicle (EELV) Secondary Payload Adapter (ESPA) ring structure with ports that may connect to payloads attached to an OTV. Some embodiments of the CAB use the ESPA ring as a referential starting point but contain hexagonal-shaped ring structures instead of circular ones. Some embodiments contain a circular ring structure connected to an external hexagonal plate structure which includes a standard ESPA ring or ESPA ring derivative as a base.

A generic ESPA ring structure consists of a hollow cylindrical structure where the top and bottom may be used as large ports (herein referred to as the front/forward port and rear/backward port respectively) and the curved side contains multiple smaller ports (herein referred to as the side, primary, or auxiliary ports). Certain ESPA rings may contain side ports of multiple sizes to attach adapters that hold different-sized payloads.

In a preferred embodiment, ESPA Rings consist of a system in which secondary payloads can be attached to a spacecraft being sent into space. The secondary payloads are released sometime after initial payloads are released from a launch vehicle (LV) or rocket. In most embodiments, these initial payloads are orbital transfer vehicles (OTVs) that contain the secondary payloads. In most embodiments, these secondary payloads are cubesats, cubesat deployers, or microsats being deployed into a specific orbit by the OTV.

The ESPA standard can include ring structures with varying levels of payload ports around a central axis. This allows for the attachment of payloads to the side ports on the OTV in a circular orientation while allowing a major (backward) port on one side to connect to the launch vehicle (LV) and a major (forward) port on the opposite side to connect to a large payload or adapter able to hold multiple payloads on a single port.

In some embodiments, the ports on the ESPA ring will typically comprise a flange with a circular/perimeter bolt pattern for attaching payloads. This is not necessary but provides a way to attach adapters to the ESPA ring without the need to correct for the curvature of the ring structure itself. Smaller ports will be less affected by the curvature of the ESPA ring and may be less likely to include this flange.

The ESPA Ring may be part of the mechanical interface that connects the OTV or primary payload to the LV. The OTV may attach to the LV by a mount system in which a large (rear) port of the ring is attached to the primary payload attachment device or adapter on the LV. The main purpose of the mechanical interface is for attaching the satellite to the launch vehicle via the Payload Adapter (PLA) housed on the LV. This mounting system can differ in mechanical arrangement, mechanical properties, elemental construct, physical sizing, fastener usage, and deployment mechanisms. These PLAs may also be similar to the ones attaching the secondary payloads to the OTV though the systems may also differ. Certain detachment systems may also use electrical, chemical, mechanical, thermal, or pyro detachments methods. These detachment methods may vary per port on the OTV but will most likely be the same type of detachment method for each mission. A preferred embodiment uses a combination of electrical and mechanical detachment methods for the detachment of the OTV from the LV and the detachment of the secondary payloads from the OTV. Some embodiments may include a release mechanism made with explosive bolts of other pyrotechnic elements for the release of payloads when prompted by the avionics system.

Some embodiments may contain an entire detachment system and apparatus for the detachment of the OTV from the LV. This detachment system will fit into the ESPA ring structure as well as the LV PLA port. This detachment system may also be used if there is a size discrepancy between the ESPA ring and the PLA. The detachment system may be any shape, but is normally either cylindrical, cone, or semi-cone shaped to allow for the attachment of the rear ESPA port to the detachment system.

The electrical interface may be part of the avionic system provided for the detachment of payloads from the OTV, the release of cubesats from the cubesat deployers, and the initial release of the OTV from the LV. This electrical interface may be housed anywhere on or in the OTV, but the hollow aspect of the ESPA ring allows for a large internal area for housing and shielding sensitive equipment such as the electrical interface or avionics system from radiation.

Fundamentally, payload ports have bolt mounting features allowing the direct coupling of secondary payloads to the payload ports of the ring. A secondary fairing system houses the secondary payload and allows the mechanical interface to the ring. There is an internal mounting system for the payload as well as one external to the ring. The fairing system has a door that can be opened, and in some cases can hold multiple payloads with multiple doors to release them one by one. Sizes and shapes can be employed as necessary for both the doors and the enclosure as a whole. Doors can be opened via frangible bolts, pyrotechnic firing elements, spring tension, pin pullers, springs, etc. In some embodiments, the payload ports may be connected through means other than bolts, such as welding, adhesive, or manufacturing of larger pieces.

The payloads on the OTV may be coated or have various insulation or vibroacoustic foam on any internal or external surface. Payloads themselves can come in various types and configurations. These aspects may serve to provide functionality and longevity of the payloads against radiation or thermal damage that may be caused by direct contact with sunlight while in space. Certain elements such as electrical or avionics systems may be pointed away from the sun or shielded by other less fragile elements such as those made of aluminum, copper, titanium, or aluminum alloy. These elements are likely to be used in spacecraft because of their low cost, ability to shield against radiation, and lightweight properties.

The ESPA ring may provide interfaces for the launch vehicle and secondary payloads via electrical power, telemetry connection, communication connections, antenna connections, umbilical connections, cooling/heating ducts or piping, airflow ducts, or fluid exchange.

Internal environments for differing fairings can be provided. Specifically, vibration, temperature, pressure, particulate contamination, moisture, and electrical power can change from one fairing to another.

Often secondary payloads receive contamination during launch. As such, enhanced protection from external environments during launch and deployment such as electromagnetic interference, electromagnetic weapons, optical countermeasures or weapons, or resistance to debris may be employed. Using separate secondary fairings may allow operators or technicians to visually determine conditions of payments via external inspection or internally mounted cameras. Final assembly can be sealed and closed in such a manner to prevent harm and damage in mounting.

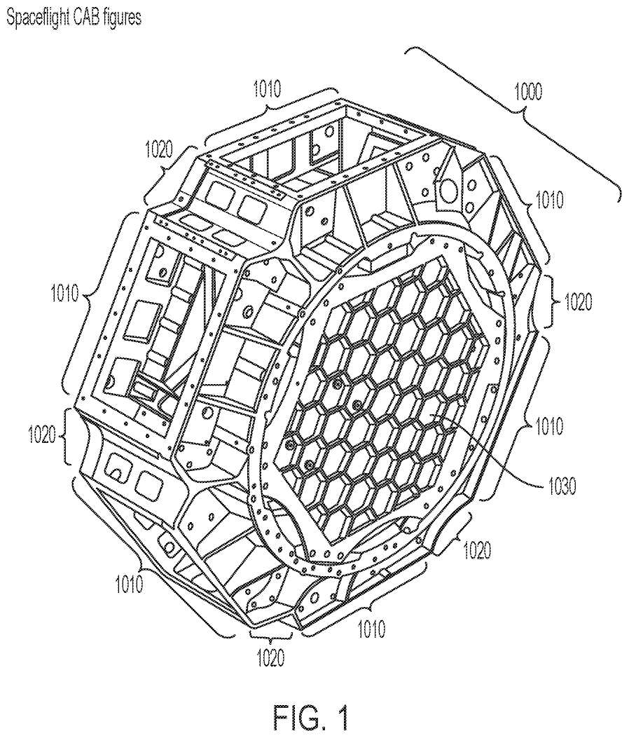

FIG. 1 is a forward-facing view of the CAB structure with views of the front port, primary ports, and auxiliary ports. The primary ports 1010 are adjacent to the auxiliary ports 1020 in the CAB structure 1000. In FIG. 1, a hexagonal plate/honeycomb structure 1030 is used to create better stability and durability while using less material. In some embodiments, this structure may help to save costs. Some embodiments may include a honeycomb/multi-hexagonal structure on other parts of the OTV to provide better stability. In some embodiments, these honeycomb structures may be used in place of a port (forward port, primary port, auxiliary port) when no payloads need to be connected to the port.

The primary ports 1010 are used to hold payloads of varying sizes, these ports may hold cubesat dispensers/deployers of up to 12 U. Some embodiments may include using the primary ports 1010 to hold smaller payloads such as 8 U, 6 U, 4 U, small microsats, avionics units, or solar panels. Some embodiments may include a larger payload depending on the materials used to create the plates attached to the primary ports 1010. In most embodiments, the auxiliary ports 1020 may hold up to 4 U cubesat dispensers, though some embodiments may include using a more durable plate to allow for a larger payload.

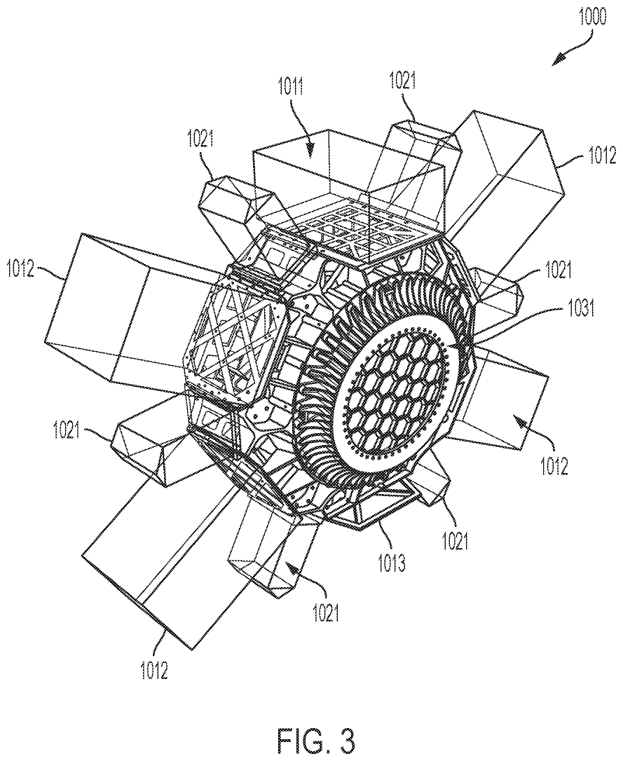

FIG. 3 is a view of the CAB 1000 shown in FIG. 1 with clear boxes to show possible spaces for payloads 1011, 1012, 1021. Alternate primary port 1013 may hold payloads, electronics systems, or weight to balance the OTV and payloads while in flight. The forward port adapter 1031 may be connected on the CAB 1000 at the area containing the honeycomb structure 1030.

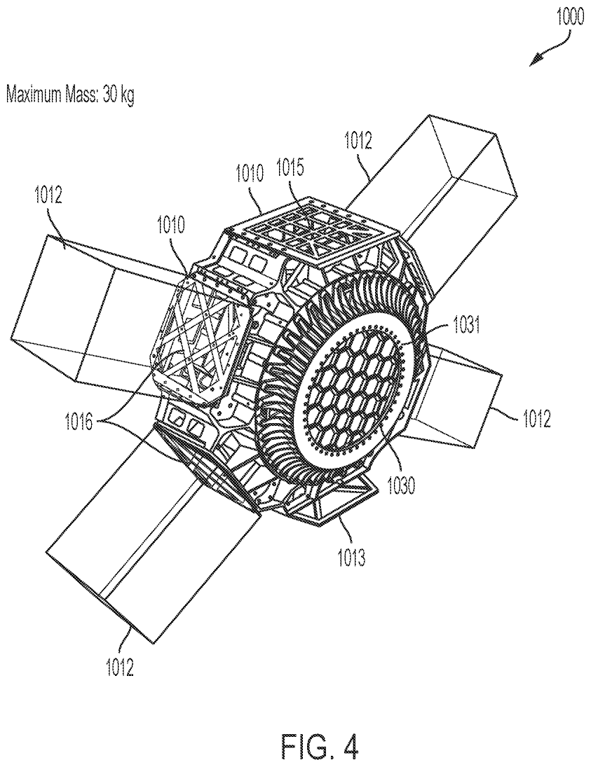

FIG. 4 is a more in-depth view of the primary ports shown in FIG. 3. The primary payload outlines 1012 are shown to provide an estimated size of a payload connected an adapter plate 1015, 1016, which connects to the payloads to the primary port 1010 on the CAB 1000. These payload outlines are used a guide to better understand the present invention, other embodiments include the use of payloads that do not conform to these sizes and shapes exactly.

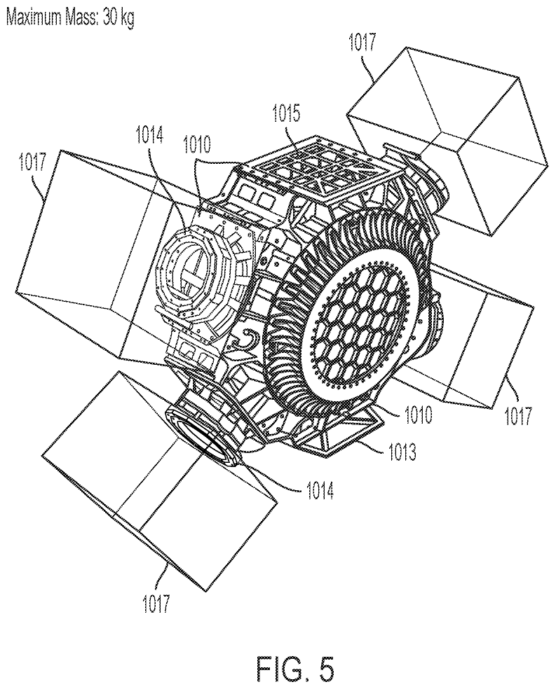

FIG. 5 is a more in-depth view of the primary ports shown in FIG. 3 using a circular plate/port adapter 1014. The primary payload outlines 1017 are shown to provide an estimated size of a payload connected a circular adapter plate 1014, which connects to the payloads to the primary port 1010 on the CAB 1000. These payload outlines are used a guide to better understand the present invention, other embodiments include the use of payloads that do not conform to these sizes and shapes exactly.

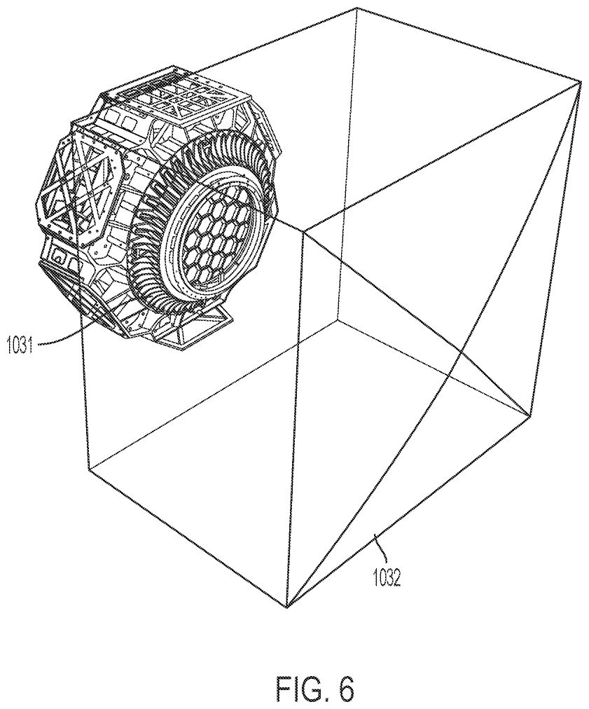

FIG. 6 is a view of the forward port on the CAB 1000 shown in FIG. 1. The forward payload outline 1032 is shown to provide an estimated size of a payload connected to the forward port 1031 on the CAB 1000. This payload outline is used a guide to better understand the present invention, other embodiments include the use of payloads that do not conform to these sizes and shapes exactly.

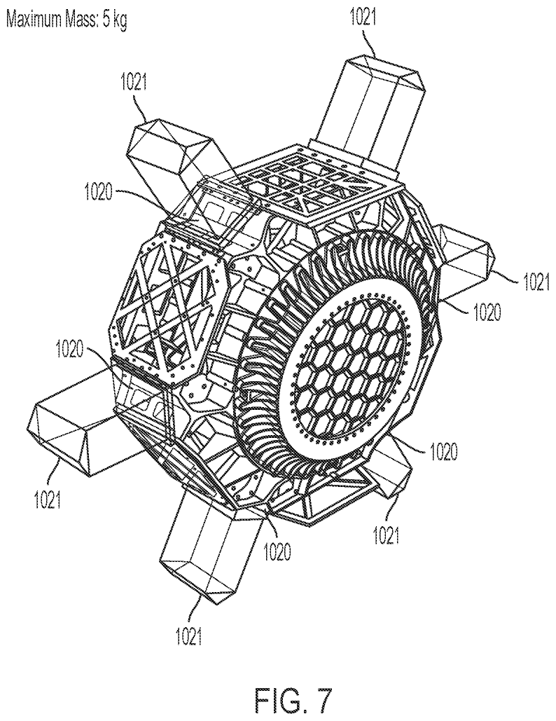

FIG. 7 is a more in-depth view of the auxiliary ports shown in FIG. 3. The auxiliary payload outlines 1021 are shown to provide an estimated size of a payload auxiliary port 1020 on the CAB 1000. These payload outlines are used a guide to better understand the present invention, other embodiments include the use of payloads that do not conform to these sizes and shapes exactly. There may be an adapter plate between the auxiliary payload and the auxiliary port. All adapter plates mentioned may include places to connect to multiple payloads at once. This allows the CAB 1000 to hold multiple payloads on each port. Some embodiments include holding payloads owned by different companies/customers on the same port.

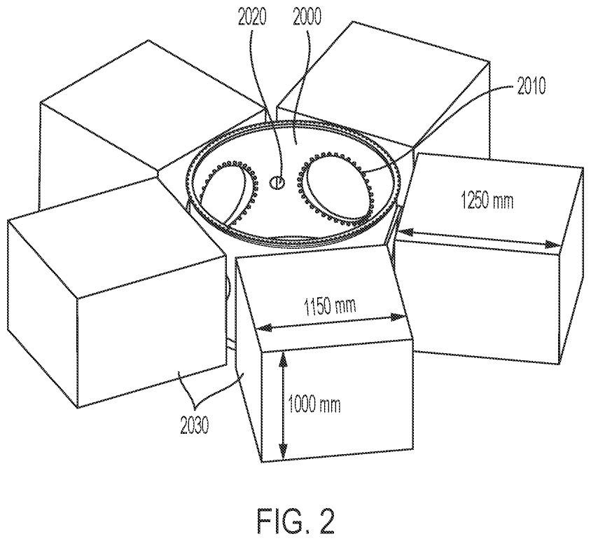

FIG. 2 is a view of a 5-sided ESPA ring 2000 containing 5 primary ports 2010, 5 auxiliary ports 2020, a rear port, and a front port. The primary ports 2010 contain payloads 2030. The figure displays payloads that are 1150×1000×1250 mm\hat{ }3. Payloads of this size may also be connected to 6-sided ESPA rings. The dimensions indicated in this figure are used as a reference for the size of the ESPA ring. The sizes for the payloads may be larger or smaller depending on many factors such as the shapes of the payloads, sizes of the port adapters, size of ESPA ring, number of ports on the ESPA ring, the number of ports with payloads, and the configuration on the launch vehicle. Other factors may also determine the maximum size of the payloads on the OTV.

FIG. 9 shows a close-up view of the forward port adapter 1031. This forward port adapter connects to a payload. The payload on the forward port is preferably larger than the payloads on the auxiliary and primary ports because of the larger size of the port adapter. It would be possible to hold multiple smaller payloads on the forward port with the addition of a special adapter port that has multiple port connections for payloads.

### (2) Cubesat and Microsat Payloads

A CubeSat is a class of miniaturized satellite based around a form factor consisting of 10 cm (3.9 in) cubes. CubeSats have a mass of no more than 2 kg (4.4 lb) per unit, and often use commercial off-the-shelf (COTS) components for their electronics and structure. CubeSats are put into orbit by deployers on the International Space Station or launched as secondary payloads on a launch vehicle.

The CubeSat specification accomplishes several high-level goals. The main reason for miniaturizing satellites is to reduce the cost of deployment: they are often suitable for launch in multiples, using the excess capacity of larger launch vehicles. The CubeSat design specifically minimizes risk to the rest of the launch vehicle and payloads. Encapsulation of the launcher-payload interface takes away the amount of work that would previously be required for mating a piggyback satellite with its launcher. Unification among payloads and launchers enables quick exchanges of payloads and utilization of launch opportunities on short notice.

Standard CubeSats are a type of nanosat are made up of 10 cm×10 cm×11.35 cm (3.94 in×3.94 in×4.47 in) units designed to provide 10 cm×10 cm×10 cm (3.9 in×3.9 in×3.9 in) or 1 l (0.22 imp gal; 0.26 US gal) of useful volume, with each unit weighing no more than 2 kg (4.4 lb). The smallest standard size is 1 U, consisting of a single unit, while the most common form factor was the 3 U, which consists of over 40% of all nanosatellites launched to date. Larger form factors, such as the 6 U and 12 U, are composed of 3 Us stacked side by side.

Smaller, non-standard form factors also exist; The Aerospace Corporation has constructed and launched two smaller form CubeSats of 0.5 U for radiation measurement and technological demonstration, while Swarm Technologies has built and deployed a constellation of over one hundred 0.25 U CubeSats for IoT communication services.

No electronics form factors or communications protocols are specified or required by the CubeSat Design Specification, but COTS hardware has consistently utilized certain features that many treat as standards in CubeSat electronics. Most COTS and custom-designed electronics fit the form of PC/104, which was not designed for CubeSats but presents a 90 mm×96 mm (3.5 in×3.8 in) profile that allows most of the spacecraft's volume to be occupied. Technically, the PCI-104 form is the variant of PC/104 used and the actual pinout used does not reflect the pinout specified in the PCI-104 standard. Stackthrough connectors on the boards allow for simple assembly and electrical interfacing and most manufacturers of CubeSat electronics hardware hold to the same signal arrangement, but some products do not, so care must be taken to ensure consistent signal and power arrangements to prevent damage.

Care must be taken in electronics selection to ensure the devices can tolerate the radiation present. For very low Earth orbits (LEO) in which atmospheric reentry would occur in just days or weeks, radiation can largely be ignored and standard consumer grade electronics may be used. Consumer electronic devices can survive LEO radiation for that time as the chance of a single event upset (SEU) is very low. Spacecraft in a sustained low Earth orbit lasting months or years are at risk and only fly hardware designed for and tested in irradiated environments. Missions beyond low Earth orbit or which would remain in low Earth orbit for many years must use radiation-hardened devices. Further considerations are made for operation in high vacuum due to the effects of sublimation, outgassing, and metal whiskers, which may result in mission failure.

Attitude control (orientation) for CubeSats relies on miniaturizing technology without significant performance degradation. Tumbling typically occurs as soon as a CubeSat is deployed, due to asymmetric deployment forces and bumping with other CubeSats. Some CubeSats operate normally while tumbling, but those that require pointing in a certain direction or cannot operate safely while spinning, must be detumbled. Systems that perform attitude determination and control include reaction wheels, magnetorquers, thrusters, star trackers, Sun sensors, Earth sensors, angular rate sensors, and GPS receivers and antennas. Combinations of these systems are typically seen in order to take each method's advantages and mitigate their shortcomings. Reaction wheels are commonly utilized for their ability to impart relatively large moments for any given energy input, but reaction wheel's utility is limited due to saturation, the point at which a wheel cannot spin faster. Examples of CubeSat reaction wheels include the Maryland Aerospace MAI-101 and the Sinclair Interplanetary RW-0.03-4. Reaction wheels can be desaturated with the use of thrusters or magnetorquers. Thrusters can provide large moments by imparting a couple on the spacecraft but inefficiencies in small propulsion systems cause thrusters to run out of fuel rapidly. Commonly found on nearly all CubeSats are magnetorquers which run electricity through a solenoid to take advantage of Earth's magnetic field to produce a turning moment. These provide torque to the cubesat in-order to spin it around and change its axis and orientation in space. In some embodiments, attitude-control modules and solar panels feature built-in magnetorquers. For CubeSats that only need to detumble (the prevention of spinning), no attitude determination method beyond an angular rate sensor or electronic gyroscope is necessary. Some embodiments may still include extra attitude control in these instances to serve other purposes such as attitude tracking compared to other objects in space.

Pointing in a specific direction is necessary for Earth observation, orbital maneuvers, maximizing solar power, and some scientific instruments. Directional pointing accuracy can be achieved by sensing Earth and its horizon, the Sun, or specific stars. Sinclair Interplanetary's SS-411 sun sensor and ST-16 star tracker both have applications for CubeSats and have flight heritage. Pumpkin's Colony I Bus uses an aerodynamic wing for passive attitude stabilization. Determination of a CubeSat's location can be done through the use of on-board GPS, which is relatively expensive for a CubeSat, or by relaying radar tracking data to the craft from Earth-based tracking systems.

CubeSats use solar cells to convert solar light to electricity that is then stored in rechargeable lithium-ion batteries that provide power during eclipse as well as during peak load times. These satellites have a limited surface area on their external walls for solar cells assembly, and has to be effectively shared with other parts, such as antennas, optical sensors, camera lens, propulsion systems, and access ports. Lithium-ion batteries feature high energy-to-mass ratios, making them well suited to use on mass-restricted spacecraft. Battery charging and discharging is typically handled by a dedicated electrical power system (EPS). Batteries sometimes feature heaters to prevent the battery from reaching dangerously low temperatures which might cause battery and mission failure.

The rate at which the batteries decay depends on the number of cycles for which they are charged and discharged, as well as the depth of each discharge: the greater the average depth of discharge, the faster a battery degrades. For LEO missions, the number of cycles of discharge can be expected to be on the order of several hundred.

Due to size and weight constraints, common CubeSats flying in LEO with body-mounted solar panels have generated less than 10 W. Missions with higher power requirements can make use of attitude control to ensure the solar panels remain in their most effective orientation toward the Sun, and further power needs can be met through the addition and orientation of deployable solar arrays, which can be unfolded to a substantially larger area on-orbit. Recent innovations include additional spring-loaded solar arrays that deploy as soon as the satellite is released, as well as arrays that feature thermal knife mechanisms that would deploy the panels when commanded. CubeSats may not be powered between launch and deployment, and must feature a remove-before-flight pin which cuts all power to prevent operation during loading into the P-POD. Additionally, a deployment switch is actuated while the craft is loaded into a P-POD, cutting power to the spacecraft and is deactivated after exiting the P-POD.

Different CubeSat components possess different acceptable temperature ranges, beyond which they may become temporarily or permanently inoperable. Satellites in orbit are heated by radiative heat emitted from the Sun directly and reflected off Earth, as well as heat generated by the craft's components. CubeSats must also cool by radiating heat either into space or into the cooler Earth's surface, if it is cooler than the spacecraft. All of these radiative heat sources and sinks are rather constant and very predictable, so long as the CubeSat's orbit and eclipse time are known.

Components used to ensure the temperature requirements are met in CubeSats include multi-layer insulation and heaters for the battery. Other spacecraft thermal control techniques in small satellites include specific component placement based on expected thermal output of those components and, rarely, deployed thermal devices such as louvers. Analysis and simulation of the spacecraft's thermal model is an important determining factor in applying thermal management components and techniques. CubeSats with special thermal concerns, often associated with certain deployment mechanisms and payloads, may be tested in a thermal vacuum chamber before launch. Such testing provides a larger degree of assurance than full-sized satellites can receive, since CubeSats are small enough to fit inside of a thermal vacuum chamber in their entirety. Temperature sensors are typically placed on different CubeSat components so that action may be taken to avoid dangerous temperature ranges, such as reorienting the craft in order to avoid or introduce direct thermal radiation to a specific part, thereby allowing it to cool or heat.

A small satellite, miniaturized satellite, or smallsat is a satellite of low mass and size, usually under 1,200 kg (2,600 lb). While all such satellites can be referred to as “small”, different classifications are used to categorize them based on mass. Satellites can be built small to reduce the large economic cost of launch vehicles and the costs associated with construction. Miniature satellites, especially in large numbers, may be more useful than fewer, larger ones for some purposes—for example, gathering of scientific data and radio relay.

The term “microsatellite” or “microsat” is usually applied to the name of an artificial satellite with a wet mass between 10 and 100 kg (22 and 220 lb). However, this is not an official convention and sometimes those terms can refer to satellites larger than that, or smaller than that (e.g., 1-50 kg (2.2-110.2 lb)). Sometimes, designs or proposed designs from some satellites of these types have microsatellites working together or in a formation.

Information on cubesat deployers, dimensions of cubesats, and dimensions of microsats.

Information on the ability to add more volume and mass to the CAB structure without compromising the mission. Additional volume is possible because of the extra auxiliary/small ports that may hold 3 U cubesat deployers or 4 U hosted payloads. These hosted payloads may be released without the need for a cubesat deployer and eject the payloads directly into space.

### (3) Configurable Annex Base (CAB)

The Configurable Annex Base (CAB) is a derivative of the ESPA ring that includes a hexagonal frame in place of a circular one. In some embodiments, this frame may also be pentagonal, triangular, rectangular, etc. The CAB's shape allows for the placement of up to 12 ports on the side of the OTV structure without the need for increasing the size of the OTV when compared to standard OTVs. In a preferred embodiment, the ports on the CAB are not built into the ESPA ring structure but instead allow for plates to be attached to the CAB. The plates attached may be circular, square, rectangular, oblong, or any other shape including non-standard shapes such as a “pocketed plate”, which allows for multiple payloads to be added to a single port.

This hexagonal shape also allows for the plates to be flat instead of curved when attached to the CAB. Because these plates are flat, any adapter can be configured to attach to the OTV including adapters that hold multiple payloads. The ability to hold any shaped plate as well as switch the plates on the structure when necessary allows the CAB structure to hold payloads of any size or shape on any port. In some embodiments, the payloads connected to the CAB may be Cubesats, Microsats, or other satellites. In certain embodiments, the payloads may be replaced with propellant tanks, avionics systems, solar panels, or other elements to allow more space for systems of operation of the OTV. This may allow the OTV to release payloads in farther orbitals without increasing its overall size. In a preferred embodiment, the weight of the payloads is distributed in a way that allows weight to be balanced in at least some manner. For example, having payloads of similar weight on opposite sides of the CAB structure to balance the weight during liftoff, flight, and movement throughout space. In some embodiments, additional weight may be added to one side of the CAB to balance the weight of payloads with different weights on opposite sides.

The CAB may provide a reduction of radiation directly to the R2A core. Based on the mass allocated to each connector in the side lids for structural analysis purposes, there's a 13× (Shell size B) to 37× (Shell size F) the mass of the ˜4 mm of aluminum that would otherwise plug each connector hole. Not all of that allocated connector mass is covering the hole, and not all of that allocated connector mass is aluminum (or better) in terms of radiation shielding. To first order, there's probably enough copper wiring and aluminum (connector+backshell) to block radiation “leaking” through the connectors and their holes in the R2A-Core Enclosure. Even though there may be some margin in the allocated connector mass, it's not off by more than a factor of 2×. That still leaves a minimum factor of 6× of shielding compared to 4 mm thick aluminum. A portion of the overall connector assembly (specifically the insulators) is less dense than aluminum, while other portions (the copper inserts and wiring) are denser than aluminum.

Many aluminum alloys are known to shield radiation better than aluminum itself, and they also keep their flexibility and do not weaken over time from exposure to the sun. These alloys may be used in any part of the CAB structure in place of pure aluminum to reduce the deterioration of the CAB structure from solar radiation. This deterioration is not a problem in most missions because of the short mission time from launch to the release of payloads (up to 36 hours in most cases). Aluminum is less expensive than its aluminum alloy counterpart, so in most cases, aluminum will be sufficient for the mission.

The core structure will help in the integration of the OTV to the LV. With integration, OTV can be sent to space attached to LV. Structural design helps to dock and undock payloads from all or most Launching vehicles.

The integration will connect all the required equipment on the OTV in a manner that they remain intact in space and do not get damaged easily so that every piece of equipment works together for a longer period of time.

Structural design and architecture afford greater control and rigidity to heavy loads especially if they have to be deployed in GEO, MEO, LLO, NRHO orbits.

The CAB also allows the OTVs flying through regions of high radiation to maintain a regular course and not have significant changes or sudden failures due to an unexpected amount of radiation. Affords 20 krad (Si), 37 MeV-cm2/mg of radiation. Will schedule memory scrubbings to reduce the risk of radiation upsets, which may negatively affect key electronics. Some embodiments may contain a CAB with different materials. The materials chosen for the base of the CAB are determined by the cost of the materials, the weight of the materials, and the amount of radiation shielding provided by the materials. Other factors such as weight of payload, weight of OTV, maximum weight allowed on the LV, etc., may also be considered when choosing a base material for the CAB

Secondary structures and adapters Allow for fast last-minute adjustments in terms of both the payloads and the launching patterns in cases of error or sudden changes in launches and flight plans for the vehicle.

The propulsion decks can be reconfigured as necessary so that they can quickly be made available or ready for sudden mission requirements. Affords less prep time and allows for quicker adjustments should issues arise.

Sherpa's core structure is the CAB (Configurable Annex Base). Designed for modularity and flexibility while maintaining a low mass, the CAB is common across all Sherpa variants. It has a 24-inch bolt circle interface on either end, six Primary Ports, and six Auxiliary Ports. The Primary Ports feature a standardized mechanical interface to which adapter plates are attached to mate with dispensers, separation systems, or a particular interface for a hosted payload. All Sherpa structural components are designed for 100% demise upon atmospheric entry.

The CAB provides an ideal platform for hosted payloads. Smaller payloads can be hosted on typical rideshare missions, enabling customers to fly their payload without requiring an entire satellite. In some embodiments, larger payloads or those requiring dedicated capabilities may use an entire OTV as an off-the-shelf, highly maneuverable bus.

The CAB Block 2 (CAB-B2) is made up of multiple rings. Some embodiments may contain a C-ring. The C-ring is the backbone of the CAB-B2 and all ports mount directly into the C-ring. This ring allows for greater space between the base of the CAB and the payloads

Some embodiments may also include a 24′ spacer ring. The 24′ spacer ring is required to offset the side ports in the SpaceX keep-in. It is located between the C-ring and Launch Vehicle interface (the system that connects the OTV to the LV). This specifically integrates with the other elements of the CAB which are also 24′ in diameter.

The CAB-B2 (CAB Block 2) is lowered onto the propulsion system and secured through the J-channel. There are multiple different cabs: parallel, angled, large, small, etc.

### (4) CAB Adapter Plates and Payload Connection

The CAB-side mating surface is an adapter plate that allows for the attachment of large payloads to the CAB.

Sherpa-CAB-side mating surface (DATUM A) has GTOL Flatness Zone of 0.005. Plate mounts to CAB (Hex Plate and Corner Brace) using 14×¼-28 fasteners. The 10 counterbore holes, ø0.280 (min) thru, have position GTOL of ø0.015 (0.015=(0.280−0.25)/2). This also matches previous installations. On the corner braces, there are 3 holes on each, ¼-28 Helicoils, that have a position GTOL is ø0.008. On the hex plates. there are 2 holes on each one, ¼-28 Helicoil, with position GTOL ø0.007. Noting corner brace size tolerances of 0.005]. The adapter plate also has the 4 middle Helicoil inserts, ¼-28, with a position GTOL of ø0.007. These will align with the through holes on hex plate [hexplate through hole of ø0.280 (min) with position GTOL of ø0.014. Note the Corner Brace size tolerance of 0.005]. Deployer side mating surface has a parallel GTOL Zone of 0.010 with respect to datum A to match 0.010 general profile GTOL Zone of CSD and ISIPOD deployers. All around general profile GTOL zone of 0.015 for other cutouts and pockets.

Design of adapter plate considered multiple case uses for possible future missions. Case 1 is single centerline mounted of 3 U CSD (Applicable to Sherpa-FX3, SXRS-6). Case 2 is single centerline mounted ISIPOD or loaded ISIPOD mass model. Case 3 is double side-by-side mounted 3 U CSD. Case 4 is single centerline mounted 6 U CSD.

The AUX-AP Adapter Blank is an adapter plate that allows for payloads to be attached to the auxiliary ports on the CAB. These ports are designed to fit 3 U Cubesats or 4 U hosted Cubesats. The addition of these plates on the CAB allows for up to 6 more payloads to be added to each mission. Embodiments with more auxiliary plates will allow for more payloads than 6, and some auxiliary ports are not limited to a single payload depending on the size and shape of the neighboring payloads.

The CAB structure was also built to connect to an LV separation system to detach the OTV from the LV. This system is connected to the rear port of the CAB. In some embodiments, this separation system is made in-house or by a third-party manufacturer. In some embodiments, the OTV may use the Mark II Motorized Lightband (MLB) space vehicle separation system to separate the OTV from the LV once in space. Any LV separation systems may be used and connected to the CAB system. These separation systems may include electrical, mechanical, chemical, or pyrotechnic-based mechanisms to separate the OTV from the LV.

The Mark II Motorized Lightband separation system is a mechanical spring-based separation system that can easily attach to the CAB rear port because of its circular nature. Circular separation systems work well with the CAB structure because they easily attach to elements like the 24′ ring spacer which is also circular. Some embodiments may include a square-shaped or rectangular separation ring that connects to the CAB via an adapter. This adapter may include a piece that connects to the rear port of the CAB on one side and the separation ring on the other side. The CAB system was built for customizability and may be adapted to connect with any separation system either directly or via an adapter piece.

These separation systems may be scaled down to connect to the side ports of the CAB and allow connection to the payloads. The motorized lightband system is used because it is lightweight compared to a clamp-band separation system, but the CAB is also able to attach to most industry standard clamp-band separation systems without the need for an adapter. If needed, an adapter may be created to allow for other separation systems to attach to the CAB.

Some embodiments may include slightly different CABs of larger or smaller size to allow for larger payloads or fewer materials to be used on a mission. The size of the spacer ring, J-channel, CAB-block, and C-ring may also be scaled with the size of the CAB. Larger propellant tanks would be possible on an OTV with a larger-sized CAB structure. This may allow the OTV to release payloads in further orbitals. The standard size of the CAB was chosen based on the space available in most standard LVs used for rideshare missions.

The avionics system and flight software may include automatic separation based on the location of the OTV in space or based on the separation of the nose cone/fairing from the launch vehicle. In some embodiments, the OTV may be separated from the LV manually based on data acquired through video, audio, sensors, or other telemetry data. There may also be a manual failsafe put in place in addition to an automatic separation system in use. This allows for a backup in case the automatic separation fails.

Some embodiments may use a similar separation system to separate payloads from the OTV. This separation system may be a scaled-down version of the LV separation system. These may be connected to the side ports of the CAB to allow for the connection of microsats to the OTV. These microsats may be deployed in various sequences determined by one or more algorithms in the flight software.

Most cubesat deployers do not contain their own electrical and power systems, so most cubesat deployers are attached via an adapter instead of a separation system. Certain cubesat deployers may contain their own internal avionics system and power source to allow them to separate from the OTV and act as a third-stage rideshare vehicle.

The adapters used to connect the cubesat deployers to the CAB are created to attach to a side port on the CAB (there may be different adapters for primary and auxiliary ports) and one of the sides of the cubesat deployer. Certain cubesat deployers may be made with a built-in port adapter that connects directly to one of the ports on the CAB. This method may save cost and allow a standardized method of building cubesat deployers. The CAB structure can hold any sized cubesat deployer (3 U, 4 U, 6 U, 8 U, 12 U, 16 U, 24 U, etc.). A standard unit (U) for each cubesat is 10×10×10 cm. This does not include the built-in port adapter if the deployer includes one. Each cubesat is fit into the cubesat deployer either with a releasable adapter or contained by a door that is opened to allow the release of cubesats into orbit.

FIGS. 4 and 5 are views CAB structures containing different adapter plates. In some embodiments, the maximum weight for the payloads attached to these adapters is 30 kg. These figures are used to show how the plates are connected to the CAB structure. The maximum weight of 30 kg is used to comply with the maximum weight allowed for a single payload on a standard LV. This weight was also chosen to balance the weight of the payload on all sides and help with the calculation of the momentum change in the OTV caused by releasing the payload into orbit. The weight and size allowed on the front of the OTV are significantly larger as shown in FIG. 6. The payload size and structure for payloads attached to the auxiliary ports are shown in FIG. 7. Some embodiments may include a larger or smaller maximum weight depending on the durability of the materials used to create the plate. Preferred embodiments may use aluminum, copper, titanium, or elemental alloys because of their low weight and high durability. Some embodiments may use a mixture of elements to create the plates. Other embodiments include payloads of different size and shape than the ones outlined in the figures. For example, some embodiments may include spherical payloads or payloads of other less common shapes.

Aluminum, titanium, copper, aluminum alloys, titanium alloys, or copper alloys are important elements in the construction of the structural parts of the OTV and the payloads. This is because these elements and alloys are lightweight, low-cost, more durable, non-toxic, and can help with the shielding of radiation. These factors are important to consider when building an OTV or payload.

### (5) Ring Spacers

Some embodiments may include ring spacers that allow for more room between elements like the CAB, the LV, the payloads, and other elements. These ring spacers may allow larger payloads to be secured to the CAB without touching other payloads attached to the OTV. These ring adapters may be either angled or parallel (flat).

Angled ring spacers allow for more space in a certain area, such as above or below the payload. If multiple angled adapters are used next to each other in opposite orientations (ex. One points up and the other points down) then larger payloads may be added without touching each other. Some embodiments include attaching angled ring spacers to the front, rear, and primary ports of the CAB to allow larger payloads to be connected to the OTV. Some embodiments may use smaller angled ring spacers attached to a plate or adapter on one of the auxiliary ports.

Parallel ring spacers allow for larger payloads to be put further away from the OTV. Some embodiments include attaching parallel ring spacers to the front, rear, and primary ports of the CAB to allow larger payloads to be connected to the OTV. Some embodiments may use smaller parallel ring spacers attached to a plate or adapter on one of the auxiliary ports. Auxiliary ports may also include long frames or other adapter structures to change the location of the payloads to be further from the CAB. This allows for wider payloads to be included on the auxiliary ports.

The 24′ spacer ring is a special parallel ring spacer that elongates the space between the OTV and the LV during the first phase of launch. This allows larger payloads to be added to the CAB without touching the shell of the LV, fairing of the LV, or other payloads on the LV. Some embodiments may include a spacer ring that is not 24′ in diameter. Other embodiments include a larger or smaller CAB size. In these embodiments, the ring spacer may be scaled to fit the new size of the CAB structure.

Some embodiments may include an angled adapter plate used to space the OTV from the launch vehicle. These plates may be bolted to the launch vehicle, OTV, or a front payload. This allows the OTV and the front payload to be angled away from other OTVs and payloads on the launch vehicle to save space.

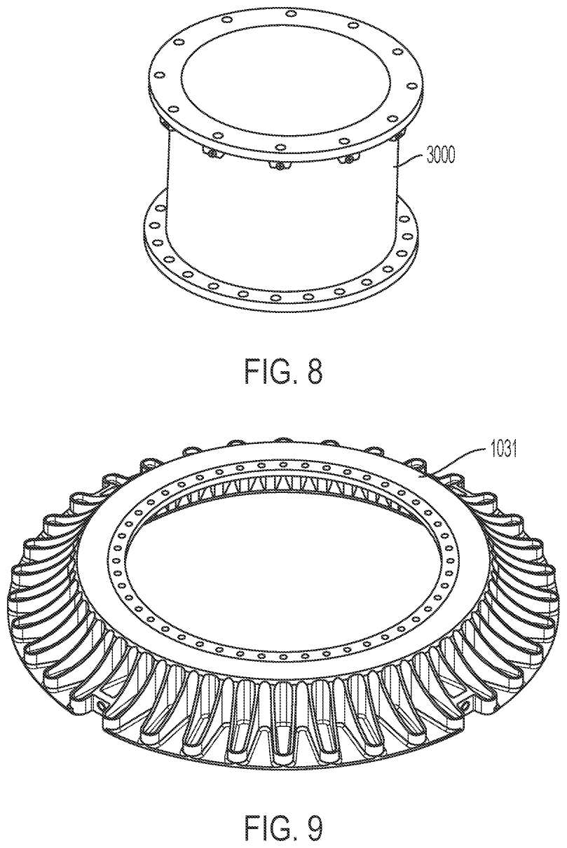

Some embodiments may include a level ring spacer used to space the OTV from the launch vehicle. FIG. 8 includes a view of one possible ring spacer 3000. It is possible to build and use other ring spacers with different widths, heights, lengths, shapes, weights, etc. These adapter rings/spacers may be connected to the Launch Vehicle interface (the system that connects the OTV to the LV) to allow for more space between the LV and the OTV, or to allow more space between the OTV and other payloads on the LV. Some embodiments may contain a spacer that is not in the shape of a ring, such as a cube or box-like spacer.

### (6) J-Channel and Propellant Systems

The J-Channel is a ring that attaches the propellant system to the CAB structure. The J-channel connects with the forward port on the CAB and locks the propellant tanks, thrusters, tank mounts, and thrust structures to the OTV. Other embodiments may include housing the avionics system in the center of the CAB and locking securing the avionics system with the J-channel. The J-channel may also contain attachments for solar panels to provide power to the rest of the OTV. This allows the OTV to collect solar energy from the sun to power its electrical systems, battery, hosted payloads, avionics system, and other systems that require power.

J-Channel information for attaching the propellant system and/or solar panels to the OTV. Propellant systems may include chemical, electrical/solar, pressurized, or dual-propellant systems.

Some embodiments may include a J-channel and propellant system. The J-channel was built to connect the Polaris propulsion system to the CAB structure. It would be possible to create a different J-channel to connect a different propulsion system to the CAB, and it would be possible to create a J-channel to connect to other ESPA rings that have a more circular cylindrical shape.

The Polaris system has four propellant tanks that are identical in design. Three of the tanks are for oxidizers (90% HTP) and the fourth is for fuel (IPA). The Polaris propulsion system has a single fuel tank for IPA storage. It is a bladder-style tank with an FEP bladder and a stainless-steel shell. It would also be possible to use oxidizers and fuel other than high-test peroxide (HTP) and isopropanol (IPA) respectively.

The primary structure of the Polaris propulsion system includes the bulkhead, thrust structure, and tank mounts/skirts. The bulkhead attaches the main assemblies of the Polaris propulsion system together (propellant tanks, thrust structure, pressurant tanks, fluid system) and mates to the Spaceflight J-Channel. It is a machined aluminum part. The tank mounts (or skirts) are cylindrical stainless-steel parts that attach the oxidizer and fuel tanks to the bulkhead. The thrust structure serves as the means of joining the thruster assemblies to the bulkhead.

Some embodiments include a propulsive holding structure containing tank mounts, a bulkhead, the J-channel ring, and a thrust structure. The propellant tanks would be held in the tank mounts during a mission. The bulkhead holds the tank mounts in place and allows for the tank mounts to be positioned inside the J-channel. The thrust structure is connected to the underside of the J-channel to hold the thrusters that would be connected to the tanks positioned in the tank mount. The J-channel may connect to the CAB structure, the LV separation system, the C-ring, or the 24′ spacer ring to allow the propulsion system to be safely connected to and stored on the OTV.

In some embodiments, the J-channel is connected to solar panel wings, the propulsion system containing the tank mounts, tanks, bulkhead, thrust structure, and thrusters in the middle, and an OTV utilizing the CAB structure.

In some embodiments, the propulsion system may be replaced for a larger payload on the front port. If there is no need for a propulsion mechanism to get passed the LEO orbit type, the space on the front port of the OTV is better used with a payload in place of the propellant system. The release of certain payloads may cause slight propulsion of the OTV. The R2A sequencer can perform calculations based on the mass of payloads and the force released to calculate the best sequence for releasing payloads to stay in the correct orbit.

The pressurant system stores high-pressure gaseous nitrogen to allow for slight corrections in the attitude. This pressurant system may connect with the attitude control system to release gas through small thrusters to correct the position of the spacecraft using the momentum from the release of the gas.

Green propellant systems such as Hypergolic Propellant with hydrocarbons and nitrous oxide. Hypergolic Propellant is a chemical propellant where components spontaneously ignite when they come into contact with each other. These compounds are usually stored in separate vessels with flow passages that allow them to enter a third vessel where they may ignite to create thrust.

### (7) Sherpa-FX, Sherpa-ES, Sherpa-AC, Sharps-LTC, and Sherpa-LTE

The present disclosure may reference a specific OTV family known as the Sherpa family. The Sherpa family of OTVs may include the Sherpa-FX, Sherpa-AC, Sharps-LTC, Sherpa-LTE, and Sherpa-ES. All of these OTVs use the CAB as the backbone of their structure. These particular OTVs are used as a reference for the present disclosure, and the pieces, parts, elements, etc. of the CAB structure and the avionics system should not be limited to these OTVs. The CAB structure's configurability allows for a single system/backbone to be used in all of the above OTVs and may be easily configured to be placed in many other OTV structures that utilize ESPA or ESPA derivative systems.

The Sherpa-FX is the original Sherpa design. It only uses the base CAB structure and allows for payloads to be attached to any of the adapters or ports on the CAB structure. It includes 6 primary ports, 6 auxiliary ports, 1 forward port to hold a larger payload or system of payloads, and 1 rear port for connection to the primary LV. The lack of a propulsion system and propellant allows it to be sent to space with less cost and safety guidelines. This allows it to be sent on missions that require a fast turnaround time for a fraction of the cost of other standard commercial OTVs.

The Sherpa-AC contains a larger and more sophisticated avionics and telemetry system than the Sherpa-FX. The top of the Sherpa-AC contains the Attitude Control System (includes solar panels, telemetry elements, and a battery with the R2A system for payload sequencing).

The Sherpa-LTC (Chemical propulsion) features a bi-propellant, green propulsion system in addition to the avionics system in the Sherpa-AC. This allows it to go to orbits past Low earth orbit (LEO).

The Sherpa-LTE (Electric propulsion) uses a Xenon propellant in addition to an electronic propulsion system. This OTV has the capability to deliver spacecraft to GEO, Cis-lunar, or Earth-escape orbits.

The Sherpa-ES allows for larger payloads to be delivered to any orbit up to GEO. The propellant tanks allow for high-velocity orbits of payloads. It uses chemical propulsion and has 5 fuel tanks, 1 in the center of the CAB, and 4 connected to four of the ports on the CAB.

### (8) Orbitals

Most companies are currently focusing on providing in-space services in LEO (Lower Earth Orbit) as higher orbits require high-impulse maneuvering capabilities. The Sherpa family of vehicles can provide rapid and cost-effective rideshare delivery of satellites to MEO, GEO, and Lunar orbit. Both Sherpa-LTC and Sherpa-ES are effectively two-stage launch vehicles that may act as multi-stage launch vehicles. The CAB structure allows for the Sherpa-ES to hold up to 5 times more propellant than a standard OTV of the same size. For many high-energy missions, this allows a smaller, less expensive two-stage launch vehicle to perform missions that would otherwise require a more expensive three-stage or multi-stage launch vehicle.

Certain embodiments may include OTVs with payloads pertaining to Cubesat deployers. These Cubesat deployers have at least one opening to allow for the deployment of Cubesats into space during the mission. These Cubesat deployers may be oriented in a variety of ways on the CAB structure. The opening on the deployers may be oriented to release the payloads 5 different orientations, 4 ways orthogonal to each other and parallel to the plate that attaches the deployer to the CAB structure, and 1 way orthogonal to the plate that attaches the deployer to the CAB structure. This effectively allows the OTV to release Cubesats in the following orientations: in front of the OTV, behind the OTV, above the OTV, below the OTV, and away from or distal to the OTV. Some embodiments may allow for other angles to be used based on certain plates or adapters attached to the CAB structure. These orientations allow for the OTV to send payloads in multiple orbits without the need for rotating during the ejection of the payloads in space. Most embodiments will contain payloads that eject away from/distal to the OTV.

Certain angled adapters may allow for the release of payloads in any orientation with respect to the CAB structure. These angled adapters may be attached directly to the CAB structure or may be connected to a plate that is connected to the CAB structure.

Some embodiments may include a device that allows for the rotation of payloads with respect to the CAB structure. This may allow the avionics system to release payloads in any orientation with respect to the CAB structure as well as release Cubesats in the same deployer into different orbits without the need for moving or rotating the entire OTV.

### (9) Radial Payload Grouping

Some embodiments include a radial payload grouping apparatus. This apparatus is used to attach multiple payloads to the front (forward) port of the OTV instead of a single larger payload.

The radial payload grouping apparatus can attach up to 4 payloads on the front port of the CAB. The triangular structure allows for larger payloads to be attached based on the wider angle between the ports. Some embodiments include the addition of parallel or angled ring spacers to allow for a larger angle between the payloads.

### (10) Pocketed Plate

Some embodiments include a pocketed plate. This plate allows for more than one payload to attach to a single port on the ESPA ring. The plate has multiple holes that allow for different sizes and shapes of payloads to be attached in different locations of the plate. The holes are for bolts to connect the adapter on the payload or cubesat deployer to the adapter port on the OTV.

In most embodiments, this plate is used to attach payloads to the primary ports of the CAB structure. The front of the plate may include small holes around slightly elevated pieces of metal. The slightly elevated metal forms shapes including a rectangle at the top, in the center, and at the bottom of the plate. The slightly elevated metal also forms dual-circle shapes enclosing a smaller circle on the left and right side of the plate. In the center of these shapes, there are larger holes. These small and larger holes are for similar-sized bolts to attach payloads to the plate.

Some specific plates may contain larger holes for bolts that do not fully go through the plate. Some embodiments include plates that have holes that go through the entire plate to allow more stable attachment of payloads to the plate. The large circle on the pack of the plate connects to a circular adapter or circular plate to attach the plate to the CAB structure. This plate may be a built-in adapter on the CAB structure itself. Other iterations of the pocketed plate may connect to the CAB directly using a slightly different layout.

Payloads may be attached to the pocketed plate directly, via an adapter, or with a separation system. This allows for smaller payloads (such as 3 U, 4 U, or 6 U deployers) to attach to the CAB without taking up space on an entire primary port.

The rear side of the plate includes indentations corresponding to where the elevated metal was on the front side of the plate. This allows for more stability without the use of more materials. It would be possible to create a thinner plate with less stability without including these indents on the front or back of the plate to cut down on the cost and the materials used. It would also be possible to create a thicker plate with more stability for the cost of more materials. These pieces as well as all other plates may be created through computer design, 3D printing, welding, or other automatic or manual methods of creating plates. In some embodiments, certain parts or pieces may also include markings or codes, pseudo-noise codes, revision codes, or Serial numbers pertaining to the part. These markings may be etched, stamped, indented, etc. into the part. The markings do not have to be visible after installation.

There are many variations of the pocketed plate including different shapes of elevated metal, more shapes or fewer shapes, different holes for bolts, and other indentations. Specific changes may be made to the pocketed plate based on certain payloads that are to be attached to it or directions that payloads must be released. Some embodiments also include using parallel or angled ring spacers between the payload and the pocketed plate. This allows for larger payloads to be attached to the pocketed plate and may allow for more payloads attached in the middle of the plate.

### (11) Attitude Control

In a preferred embodiment, an attitude control system may be connected to one of the ports on the CAB in place of a customer's payload. This allows for the determination of the spacecraft's (OTV's) location in 3-dimensional space and allows for slight adjustments to the vehicle's location to ensure payloads are released in the exact orbit predetermined by the customers and developers prior to launch.

Attitude pertains to a spacecraft's position in 3-dimensional space. Attitude control is the process of controlling the orientation of an aerospace vehicle with respect to an inertial frame. Some embodiments may use sensors to determine position based on an external reference or another entity such as the celestial sphere, certain fields, nearby objects, etc. Some embodiments may also use an internal inertial reference such as a gyroscope instead of an external inertial reference. Other embodiments may include multiple reference points such as a mixture of internal and external references or multiple external references such as an earth-sun combination sensor.

An Attitude Determination and Control System (ADCS) is a crucial subsystem of a spacecraft. It provides pointing accuracy and stability of the payloads and antennas as critical parts of the S/C operation and the mission success. The Space Engineering department is well recognized for its work on the design, development and launch of educational nano-satellites. The study and development of a complete ADCS system started within the Delfi-C3 CubeSat program being a passively controlled S/C without 3-axis stabilization. A full blown ADCS system including 3-axis pointing control and stabilization was developed within the Delfi-N3Xt CubeSat program. Key areas are hardware development and characterization (reaction wheels, sunsensors, magnetorquers and magnetometers are developed within the chair SSE), attitude estimation algorithms (see also the ESEO project), control loop design, system development and testing. The development of micro-thrusters, a reaction ball subsystem, water-propelled micro-resistojets, mostly based on MEMS technologies and huge momentum bias wheels with frictionless magnetic bearings are part of the R&D development scope. The MEMS components of these thrusters are manufactured through a collaboration with the TU Delft's Else Kooi Lab.

In order for the vehicle to go in the right direction, the attitude must be monitored and controlled. If even a tiny mistake in the way the ship is pointed isn't corrected, the ship can end up millions of miles off course. In some embodiments, attitude is controlled by tiny thrusters that contain compressed gasses, herein referred to as monopropellants. In some embodiments, these tiny thrusters may be pointed in different directions or have a mechanism of rotation to allow gas to be expelled in any direction. Expelling these gasses from the spacecraft allows it to change direction in space using additional momentum and the current momentum of the spacecraft. Firing these thrusters releases the gases to allow for small adjustments in the orientation of the spacecraft. This allows the spacecraft to stay on course in accordance with mission objectives and predetermined orientations.

The study and development of the ADCS is related to small space instruments and sensor systems development for certain classes of small satellites or payloads. These payloads may include CubeSats, PicoSats, MicroSats, etc., and should not be limited to smallsats in general, though preferred embodiments include the release of smallsats into specific orbits. In a preferred embodiment, the ADCS uses a combination of star trackers, GPS, and Inertial Measurement Units to update the flight computer on attitude, orbital velocity and position.

Controlling vehicle attitude requires sensors to measure vehicle orientation, actuators to apply the torques needed to orient the vehicle to a desired attitude, and algorithms to command the actuators based on (1) sensor measurements of the current attitude and (2) specification of a desired attitude. The integrated field that studies the combination of sensors, actuators and algorithms is called guidance, navigation and control (GNC).

Attitude control may be used in combination with recontact analysis to reduce the potential for spacecraft collision.

The attitude control system works with the R2A system to allow attitude maneuvering using the propulsion systems. The attitude control system may include any combination of attitude sensors of a multitude of types including, GPS, gyroscopic, sun sensor, earth sensor, star trackers, etc. The attitude sensors for the Sherpa-AC include STIM 210, Sinclair ST-16RT2 (1×), sun sensors, magnetometers, earth sensors, and satellite-satellite distance telemetry. These sensors communicate with a flight computer that is attached to the first port of the CAB. Other embodiments may contain any other sensors for attitude detection and spacecraft location determination. The flight computer may be located on any port of the CAB or inside the CAB structure. Embodiments may include placing the flight computer anywhere on the OTV or on a payload hosted on the OTV.

The STIM 210 is a gyroscopic sensor that can account for the movement of the OTV in an (x, y, z) or 3-dimensional plane. This can account for forward movement, backward movement, side-to-side movement, up-and-down movement, as well as any combination. Some embodiments may also be used for 1-dimensional or 2-dimensional movement tracking if 3-dimensional tracking is not needed for the mission. Other star-tracking sensors may use imaging of the stars to determine the location of the spacecraft. The flight computer uses the stars as a reference point based on the known location of the stars in comparison with the earth. This tracking system is very helpful in orbits further away from the earth or in orbits around other planets.

The Sinclair ST-16RT2 is a star tracker that may also use the moon a reference point. This allows the flight software to base the location of the OTV based off of the moon and stars. In some embodiments, this sensor may be used to track the location of an OTV used for missions in cis-lunar orbits. Based on the location of the stars in addition to the size of the moon, the flight computer can determine how close the OTV is to the moon and can deploy payloads in cis-lunar or other moon-dependent orbits more effectively.

A sun sensor may be used to track the location of the OTV based on the distance from and direction of the sun. These sensors may also be used with the avionics system to point certain payloads or sensitive components toward or away from the sun. This may allow for a reduction in the radiation exposure to the sensitive components of the spacecraft or for payloads with the purpose of sun imaging to be placed in view of the sun.

A magnetometer is an instrument for measuring the strength and sometimes the direction of magnetic fields. They enable fine attitude and orbit control of satellites and precise transformation of scientific data into inertial references. The magnetometer provides coarse attitude based on the satellite's position as determined by onboard GPS position and a model of Earth's magnetic field. In some embodiments, the moon's magnetic field is taken into consideration to allow payloads to be released in certain orbits such as cis-lunar. Some embodiments use magnetometers in addition to other object-based sensing to provide a more accurate measurement of the spacecraft's location in space.

A gyroscope may also be used to determine the attitude of spacecraft in space. Gyroscopes use the conservation of angular momentum to predict a change of angle in space. This allows gyroscopes to be used without the need for gravity and therefore useable in space.

Telemetry data from neighboring satellites may also be used to determine a spacecraft's location with respect to other objects in space. The distance between multiple satellites may be determined based on the time between a signal being sent from one satellite by another satellite.

Before attitude control can be performed, the current attitude must be determined. Attitude cannot be measured directly by any single measurement, and so must be calculated (or estimated) from a set of measurements (often using different sensors). This can be done either statically (calculating the attitude using the currently available measurements), or through a statistical filter that statistically combines previous attitude estimates with current sensor measurements to obtain an optimal estimate of the current attitude.

For some sensors and applications (such as spacecraft using magnetometers) the precise location must also be known. While pose estimation can be employed, for spacecraft it is usually sufficient to estimate the position (via Orbit determination) separate from the attitude estimation. For terrestrial vehicles and spacecraft operating near the earth, the advent of Satellite navigation systems allows for precise position knowledge to be obtained easily. This problem becomes more complicated for deep space vehicles, or terrestrial vehicles operating in Global Navigation Satellite System (GNSS) denied environments.

Certain embodiments may not have the need for an attitude control system. Precise calculations may be performed during the separation of the OTV from the launch vehicle and during each payload separation sequence.

### (12) Hosted Payloads

A hosted payload is a portion of a satellite, such as a sensor, instrument or a set of communications transponders that are owned by an organization or agency other than the primary satellite operator, which in this case is the owner of the OTV. The hosted portion of the satellite, in this case a payload pertaining to a smallsat, operates independently of the main spacecraft, but shares the satellite's power supply, transponders, and in some cases, ground systems.

Certain embodiments may include using the OTV to host payloads connected to the CAB structure to allow payloads without their own power supply or power generation systems, such as solar panels, to use the OTV as a power source and external computer system after other payloads have already been released in space. This may be useful for imaging satellites, where the R2A avionics system may be used to keep the payload pointed at a specific location on earth or in space that the imaging satellite payload wants to focus on.

A hosted payload system allows customers to send their system to space without the need to create a fully operational satellite. In some embodiments, a customer may send a payload containing an imaging system without an entire electrical or power system. This allows customers to get to space faster and with less expense.

In some embodiments, the attitude control system is used to fulfill pointing requirements of certain hosted payloads, such as an imaging payload pointed at a specific object or location. Other hosted payloads may need to be pointed at specific locations to allow data to be collected from a certain location, or to provide internet to a certain area. Other embodiments may include any other satellite with pointing requirements. Certain satellites may not have a pointing requirement and may be hosted on the same spacecraft as others that do have a pointing requirement. Certain payloads may also be hosted in a specific port on the OTV based on their pointing requirements. For example, a payload that must be pointed at earth may be on a port opposite to a payload that must be pointed at an object in space.

In some embodiments, the hosted payloads may use the communications systems on the host satellite to communicate with other entities in space and/or with ground stations. The host satellite may include multiple sensors and antennae to send and receive telemetry information from the hosted payload to its owners. This information may be relayed to a ground station and sent to the owners via a cloud-based communication system or to a ground station used directly by the customer who owns the hosted payload.

Most embodiments include OTVs that can host payloads for up to a year. This is because the OTV is designed to fall out of orbit and back into the earth's atmosphere. In most embodiments, the OTV is made in a way that this trip back through the earth's atmosphere will completely destroy all of the parts. This is done so that no large pieces of the OTV will plummet passed the earth's atmosphere and damage objects or people after freefall. Some missions may require hosting payloads for more than a year. These missions may be completed using slightly different orbits or a faster speed during orbit to prevent orbital decay.

Some OTVs may include retractable satellite wings that may be added to any of the ports on the CAB in place of a payload or multi-payload adapter plate such as the pocketed plate. These satellite wings may unfold to provide more surface area for solar absorption. This is especially useful on missions including hosted payloads because more energy may be collected from the sun to power hosted payloads that use the power of the OTV. Other energy sources may be used when a shorter hosting time is needed.

Some embodiments may include payloads that must be thermally regulated during the mission. It is possible to add heating or cooling elements near payloads if certain payloads need to be thermally regulated. These may attach to the auxiliary ports next to the payload or be connected within the deployers themselves. Some embodiments also include thermal monitors that may be placed on or in a payload to allow the flight computer to determine the internal temperature of thermally sensitive elements.

### (13) Testing of Parts, Software, Hardware, Payloads, CAB, and OTV

Testing satellites is an essential part of the satellite launch process as it ensures that the satellite will function properly in space. This testing must be done before the satellite is launched into space to avoid any costly and dangerous errors. Tests such as thermal, vacuum, vibration, radiation, transmission, tensile, and electromagnetic compatibility tests are used to simulate the extreme conditions the satellite will be exposed to in space. Additionally, tests such as functional and performance tests are used to ensure the satellite is working correctly, and that all components are compatible with each other. By testing the satellites prior to launch, engineers can ensure that the satellite will remain stable and safe once it is in orbit. All of the following tests may be performed on the OTV, the payloads, the LV, or specific components of the OTV, payloads, and LV. Some embodiments may test individual components using specific tests design to test those components.

Some embodiments may perform acceptance testing and qualification testing on satellites to ensure they function properly in space and conform to government regulations, international regulations, and customer guidelines.

Acceptance testing is the process of verifying that the satellite meets the requirements needed based on the mission being carried out. This type of testing typically takes place in a laboratory environment and is usually conducted by the manufacturer. It typically involves checking the satellite's performance against specifications, verifying the satellite's compatibility with ground stations, and verifying that the satellite can perform as expected in its intended environment.

Qualification testing is the process of verifying that the satellite will function properly in a space environment and is designed to demonstrate that the satellite can survive the harsh conditions and extreme temperatures of space. This type of testing is conducted in a simulated space environment, such as a vacuum chamber, and is usually conducted by the government or a third-party organization. It typically involves testing the satellite's performance under simulated space conditions and verifying that the satellite can withstand the environmental stresses of space.

Tensile testing of satellites is an important part of the overall quality assurance process for the design and manufacture of a satellite. It is used to measure the strength and durability of the satellite's materials and components and helps ensure that they are able to withstand the stresses experienced during launch and operation in space. The test involves applying a force to the satellite's components while measuring the resulting strain and is typically performed on selected components such as the solar panels and antennae. The results of the tensile testing are used to assess the structural integrity of the satellite and identify any potential weaknesses that could prevent it from operating as designed. Additionally, the test is used to validate the accuracy of the satellite's design, ensuring that it meets the required performance specifications.

These tests may be performed in a simulation before the tests on the physical components are performed. The force applied to each component may mimic the force estimated to occur on each component during the actual mission. These forces mostly occur during launch and when leaving the Earth's atmosphere.

Some embodiments may include tensile strength testing of all elements of the OTV, LV, and payloads to ensure the safety and stability of these elements during the mission. Some embodiments may include the physical testing of only structural elements such as bolts, brackets, fasteners, screws, etc. to ensure that more fragile elements such as the electrical components or avionics system are not harmed during the testing phase. These more fragile elements may be tested using simulation software. Other embodiments may include testing all components using simulation software.

Thermal testing of satellites is an important part of satellite design and development. It ensures that the satellite will be able to withstand the extreme temperatures, thermal stresses, and sudden extreme thermal fluctuation encountered in space and during launch. Thermal testing involves exposing the satellite to a range of temperatures and measuring its performance. This includes testing the thermal control system, insulation, and other components. The tests may be conducted in a thermal vacuum chamber, which mimics the conditions of space. In some embodiments, the satellite and its components are subjected to temperatures ranging from −100° C. to +100° C., and the performance is monitored and recorded. Other embodiments may use less extreme thresholds during testing. Thermal testing is extremely important for verifying the thermal design and ensuring the satellite will operate within its design specifications in the space environment.

Some embodiments may include Thermal Vacuum (TVAC) testing of OTVs and payloads. The TVAC test is intended to reproduce the thermal and pressure environment that a satellite experiences when orbiting in Low Earth Orbit (LEO). Some embodiment may include slight alterations in temperature for satellites and payloads being released in further orbits.

Pressure testing of satellites is a process used to ensure that a spacecraft is able to withstand the extreme pressures of space. Some embodiments may combine this testing with thermal vacuum testing to save time and money during testing. This involves subjecting the satellite to a vacuum chamber to simulate the conditions of space. During this test, the spacecraft is pressurized and depressurized to validate its structural integrity. The satellite may also be subjected to vibration, acoustic noise, and shock tests to ensure that it can withstand any potential impacts or shocks it may encounter in space. Some embodiments may include separating these tests to allow the testing of individual satellite components. Additionally, the satellite is tested for any potential leaks, ensuring that the spacecraft will be able to survive the harsh environment of space.

Pressure testing of satellites may require the use of specialized equipment. Specialized vacuum chambers are used to simulate the conditions of space, and engineers must ensure that the correct pressure and temperature settings are used to accurately simulate the environment of space. In some embodiments, the spacecraft may be evaluated for any potential damage or defects, and then any necessary repairs may be made before the satellite is launched. In some embodiments, engineers will check for any potential leaks or damage to the spacecraft after testing, as this can be catastrophic if not detected prior to launch.

Pressure testing of satellites is important for more than just ensuring structural integrity. Pressure testing also helps to validate the accuracy of the satellite's instrumentation, as any errors in the sensors or instruments can cause inaccurate readings or delayed responses. Pressure testing can also help to identify any potential sources of interference, as these can cause significant problems for spacecraft operations.

Some embodiments may include the use of radiation testing. Radiation testing of satellites involves subjecting them to a range of radiation levels and frequencies in a laboratory environment to simulate the conditions of space. This is done to assess the satellite's response to various levels of radiation and to identify any potential weaknesses in its design. By subjecting satellites to radiation testing, engineers can identify any design flaws and weaknesses that could lead to failure in space, thus enabling them to make any necessary changes before launch. Certain elements may be exposed to more radiation during the mission. These elements may be tested for their ability to handle high levels of radiation. These tests may be performed to determine how much radiation exposure is considered safe during the mission.

Some embodiments may also include testing how much radiation is shielded from sensitive components. The CAB structure may shield sensitive components from radiation exposure, and testing may be conducted to determine the amount of radiation that still reaches those components. Some embodiments may include adding additional radiation protection after the testing is completed if the amount of unshielded radiation is deemed unsafe or risky.

Some embodiments may include the testing of the satellite's transmission equipment. Transmission testing of satellites involves the use of specialized equipment and software to ensure that communications between satellites and earth-based receivers are stable and reliable. This testing includes verifying the capacity of the satellite's signal, ensuring that data is received and transmitted correctly, and checking the integrity of the data. Additionally, the transmission test will check the strength of the signal, the signal-to-noise ratio, and the frequency of the signal. This testing verifies the satellite's performance to ensure that it is functioning properly and is able to transmit data without any issues. The results of the transmission test will be used to make any necessary adjustments to the satellite's design or programming to ensure that it is functioning correctly.

In some embodiments, the transmission test can also be used to detect any changes in the satellite's environment, such as changes in the atmosphere, which can affect the satellite's performance. Additionally, the test can be used to identify sources of interference that may impact the quality of the signal. By conducting regular transmission testing, engineers can ensure that any issues can be identified and corrected quickly before they become major issues. Additional testing may be performed during the mission using the built-in self-test (BIST) software.

Some embodiments may include Electromagnetic compatibility (EMC) testing of the OTV and payloads. EMC testing of satellites is a critical part of ensuring that spacecraft will be able to successfully operate in their intended environment. It is important to verify that the satellite's components are properly shielded from electromagnetic interference and that the satellite itself does not produce interference that could adversely affect other spacecraft or Earth-based systems. It is important to understand the electromagnetic field response produced by the satellite itself under normal operation. In order to accomplish this, some embodiments perform EMC tests on each component of a satellite prior to its launch.

Some embodiments include an anechoic chamber test, which is designed to measure the amount of radiation that is emitted by the system. This data is then used to determine the minimum amount of shielding that is needed to protect the satellite from external interference. Additionally, the anechoic chamber test can check for any interference that the satellite may be producing and if needed, measures may be taken to reduce this.

Once the shielding is in place, some embodiments may conduct a radiated susceptibility test to make sure that the satellite is not adversely affected by external electromagnetic sources. This test involves exposing the satellite to various frequencies of electromagnetic radiation. If any of the components fail the test, additional shielding or shielding modifications may be necessary. Some embodiments may include using the CAB structure as an electromagnetic barrier. In these embodiments, if the tests conclude that the CAB structure does not shield an adequate amount of electromagnetic radiation, additional modifications to the CAB structure may be performed such as increasing the thickness of plates, using alternative base materials, or adding elements to the CAB that promote shielding. Other embodiments may use other methods of radiation reduction.

Certain embodiments may also include a conducted susceptibility test. This test is designed to determine if the satellite's electrical components are affected by any external electric fields. If any of the components fail the test, additional shielding may be required. The results of the tests may be used to ensure that the satellite will be able to function properly in its intended environment and that it will not disrupt other systems or other satellites in the process. This may also be used to make sure that there are no negative interactions between the payloads, the OTV, and the LV. Some embodiments may conduct these tests on individual components, payloads, the entire OTV, or the system or combined payloads and OTV.

Certain embodiments may perform verification and performance tests on the solar panels/solar arrays housed on the satellite structure. Testing of solar arrays and solar panels in satellites is important to ensure that the power generated from the solar arrays and panels will be sufficient enough to operate the satellite's systems in space. The testing procedures involve testing the solar cell efficiency, verifying the power output, and measuring the voltage and current of the solar array.

Some embodiments may use a solar cell efficiency test measures the amount of power produced by the solar cell when exposed to sunlight. This test may be done in a laboratory using a solar simulator, which mimics the light intensity and spectrum of the sun. The power output of the solar array is tested to ensure that the total power output of the solar array meets specifications. This is done by measuring the voltage and current at different angles of the solar array.

In some embodiments, the voltage and current of the solar arrays are also tested to ensure that the solar array meets its design requirements. This is done by connecting a load to the solar array and measuring the voltage and current of the array. The load can be a resistor, a battery, or a power supply.

Some embodiments may test whether the solar array is able to maintain the power output when exposed to extreme temperatures, pressure changes, or radiation. The solar cells must be directly facing the sun and will be exposed to high levels of radiation. Some embodiments may include performance tests of solar panels/arrays while exposed to radiation to ensure high levels of performance while exposed to the sun's radiation in space. In addition to the tests mentioned above, other tests may be performed on the solar arrays and panels to ensure that they meet the requirements of the specific mission. Some embodiments may also test components using computer simulations before the physical testing to determine if the components will work as expected without the cost of extra physical testing.

Some embodiments may also include In-orbit test (IOT) systems, Satellite payload testing, TRM and antenna testing, Positioning and navigation testing, GNSS testing, Ground station and ground terminal testing, Noise Power Ratio (NPR) method for testing transmissions.

What is claimed is:

1. An apparatus for holding multiple payloads on an orbital transfer vehicle (OTV), the apparatus comprising:
a base structure of an OTV, the base structure having a primary port system with at least 2 primary ports, the primary ports containing one of adapters and adapter plates that connect payloads to the OTV, the payloads connected to the OTV are one of microsats, cubesats, cubesat dispensers, avionics systems, and solar panels;
the base structure having an auxiliary port system with at least 2 auxiliary ports, wherein the number of primary ports equals the number of auxiliary ports;
the primary ports and auxiliary ports include adapters configured to connect a payload to the OTV;
the order of ports around the base structure alternates between primary and auxiliary ports;
the base structure containing a forward port capable of holding more weight than can be held by the primary and auxiliary ports;
the base structure containing a rear port capable of connecting the OTV to a launch vehicle (LV).

2. The apparatus of claim 1, wherein the primary port system includes 6 primary ports oriented around the OTV, and the auxiliary port system includes 6 auxiliary ports oriented around the OTV; the primary ports are oriented in a way that forms a 120° angle between each port around the OTV.

3. The apparatus of claim 1, wherein the primary ports may include different types of payloads on each port.

4. The apparatus of claim 1, wherein the forward port holds a payload smaller that all of the other payloads on the OTV.

5. The apparatus of claim 1, wherein the section of the primary plate configured to connect to the payload is flat and parallel with respect to the payload connected to it.

6. The apparatus of claim 1, wherein the auxiliary ports are smaller than the primary ports.

7. The apparatus of claim 1, wherein the primary port system contains primary ports that include at least one of a flat adapter plate and a circular adapter port.

8. The apparatus of 1, wherein the adapters and adapter plates on the primary ports may be easily switched out to allow for the connection of different-sized payloads to the primary ports.

9. The apparatus of claim 1, wherein the primary ports may include different adapters or the same adapters.

10. The apparatus of claim 1, wherein the primary ports are arranged in a position where each port is 120 degrees with respect to the next adjacent primary port.

11. The apparatus of claim 1, wherein the auxiliary ports are arranged in a position where each port is 120 degrees with respect to the next adjacent auxiliary port.

12. The apparatus of claim 1, wherein each primary port can hold a 12 U or smaller cubesat dispenser.

13. The apparatus of claim 1, wherein each auxiliary port can hold a 4 U or smaller cubesat dispenser.

14. The apparatus of claim 1, wherein the forward port may hold more than one payload.

15. The apparatus of claim 1, further comprising a launch vehicle interface on the launch vehicle and a ring spacer connected to the rear port of the OTV that allows the base structure to be further from the launch vehicle interface.

16. The apparatus of claim 1, wherein the adapters on the primary ports may be one of removed, exchanged, and replaced without deconstructing the OTV.

17. The apparatus of claim 16, further comprising new adapters exchanged or replaced with the adapters, wherein the new adapters are exchanged or replaced based on the payload being attached to the port.
